(19) United States
(12) Patent Application Publication
(10) Pub. No.: US 2016/0357470 A1
(43) Pub. Date: Dec. 8, 2016

(54) COMPUTER READABLE MEDIUM, INFORMATION PROCESSING APPARATUS, AND METHOD

(71) Applicant: FUJITSU LIMITED, Kawasaki-shi (JP)

(72) Inventors: Naotaka Hamaguchi, Numazu (JP); Yasuo Ueda, Numazu (JP); Toshiyuki Okajima, Numazu (JP); Nobuyuki Akiyama, Mishima (JP); Hidetoshi Seto, Sunto (JP); Hideo Shitaya, Tagata (JP); Hiroyuki Kamezawa, Numazu (JP)

(73) Assignee: FUJITSU LIMITED, Kawasaki-shi (JP)

(21) Appl. No.: 15/166,461

(22) Filed: May 27, 2016

(30) Foreign Application Priority Data
Jun. 2, 2015 (JP) 2015-112701

(51) Int. Cl. G06F 3/06; G06F 12/14

(52) U.S. Cl. CPC G06F 3/0623; G06F 3/0631; G06F 3/065; G06F 12/1408; G06F 3/0673; G06F 2212/402

(57) ABSTRACT

A method includes: allocating a first divided region in a user space to a program executed in a user mode, the first divided region being one of a plurality of divided regions obtained by dividing a storing region of a memory, storing information which indicates that the data to be stored is confidential, in association with the first divided region allocated to the program; storing, when data stored in the first divided region is copied to a second divided region in a kernel space among the plurality of divided regions of the storing region and when the information is associated with the first divided region, the information in association with the second divided region; and dumping, when the second divided region with which the information is associated is included in a dump target, encryption data which is obtained by encrypting the data stored in the second divided region.

### CROSS-REFERENCE TO RELATED APPLICATION

This application is based upon and claims the benefit of priority of the prior Japanese Patent Application No. 2015-112701, filed on Jun. 2, 2015, the entire contents of which are incorporated herein by reference.

### FIELD

The embodiments discussed herein are related to a computer readable medium, an information processing apparatus, and a method.

### BACKGROUND

For a failure investigation for a computer, there has been a technique for dumping memory data of the computer. There has also been a technique for reducing leakage of data which is confidential by outputting encryption data, which is obtained by encrypting the data which is confidential, instead of outputting the data which is confidential. As a related art, there has been, for example, a technique in which when a memory dump request is issued, important data which has been categorized as data of a predetermined important process is encrypted, and the encrypted important data is stored into a storage device. There has also been, for example, a technique in which for execution of a task, memory confidentiality protection attributes are set for a memory page to be accessed in a memory confidentiality protection attribute storing unit.

As examples of related arts, Japanese Laid-open Patent Publication Nos. 2003-186749 and 2003-280989 have been known.

However, according to the related arts, when some or all of data in a storing region of a memory are dumped, leakage of data which is confidential may occur. Specifically, for example, in the case where data which is confidential and handled by an application program is processed by a kernel, data which is obtained by copying the data which is confidential is stored in a storing region in a kernel space, which is a part of the storing region. When the data which is confidential is coped to the storing region of the kernel space, it is difficult to understand that the data of the copy destination is confidential. Therefore, when the storing region of the kernel space is dumped for a failure investigation, the data of the copy destination is dumped without encryption, and leakage of the data which is confidential thus occurs.

### SUMMARY

According to an aspect of the invention, a method includes: allocating, by a processor, a first divided region in a user space to a first program that is being executed in a user mode, the first divided region being one of a plurality of divided regions obtained by dividing a storing region of a memory, storing, by the processor, information which indicates that the data to be stored is confidential, in association with the first divided region allocated to the first program; storing, by the processor and when data stored in the first divided region is copied to a second divided region in a kernel space among the plurality of divided regions of the storing region and when the information is associated with the first divided region, the information in association with the second divided region; and dumping, by the processor in a case where the second divided region with which the information is associated is included in a dump target, encryption data which is obtained by encrypting the data stored in the second divided region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an operation example of an information processing apparatus according to a first embodiment;

FIG. 2 is an explanatory diagram illustrating an example of a hardware configuration of the information processing apparatus;

FIG. 3 is an explanatory diagram of regions for handling a region with a size smaller than a page;

FIG. 4 is an explanatory diagram illustrating an example of a functional configuration of the information processing apparatus;

FIG. 5 is an explanatory diagram illustrating an example of stored contents of management information;

FIG. 6 is an explanatory diagram illustrating an example in which a confidential information storage region is secured;

FIG. 7 is an explanatory diagram illustrating an example of setting of a confidentiality flag;

FIG. 8 is a flowchart illustrating an example of a procedure for a confidentiality flag setting process;

FIG. 9 is a flowchart illustrating an example of a procedure for a memory clear process;

FIG. 10 is a flowchart illustrating an example of a procedure for a buffer region copy process;

FIG. 11 is an explanatory diagram illustrating an example of memory dump collection;

FIG. 12 is a flowchart illustrating an example of a procedure for a memory dump collection process;

FIG. 13 is a first flowchart of an example of a procedure for a decryption process;

FIG. 14 is a second flowchart of an example of the procedure for the decryption process;

FIG. 15 is an explanatory diagram illustrating an operation example of a system according to a second embodiment;

FIG. 16 is a flowchart illustrating an example of a procedure for a confidentiality flag setting process according to the second embodiment;

FIG. 17 is a first flowchart illustrating an example of a procedure for a memory dump collection process according to the second embodiment; and

FIG. 18 is a second flowchart illustrating an example of the procedure for the memory dump collection process according to the second embodiment.

### DESCRIPTION OF EMBODIMENTS

An aspect of an embodiment is to reduce leakage of data which is confidential and stored in a storing region.

Hereinafter, a dump processing program, an information processing apparatus, and a dump processing method according to embodiments will be described with reference to drawings.

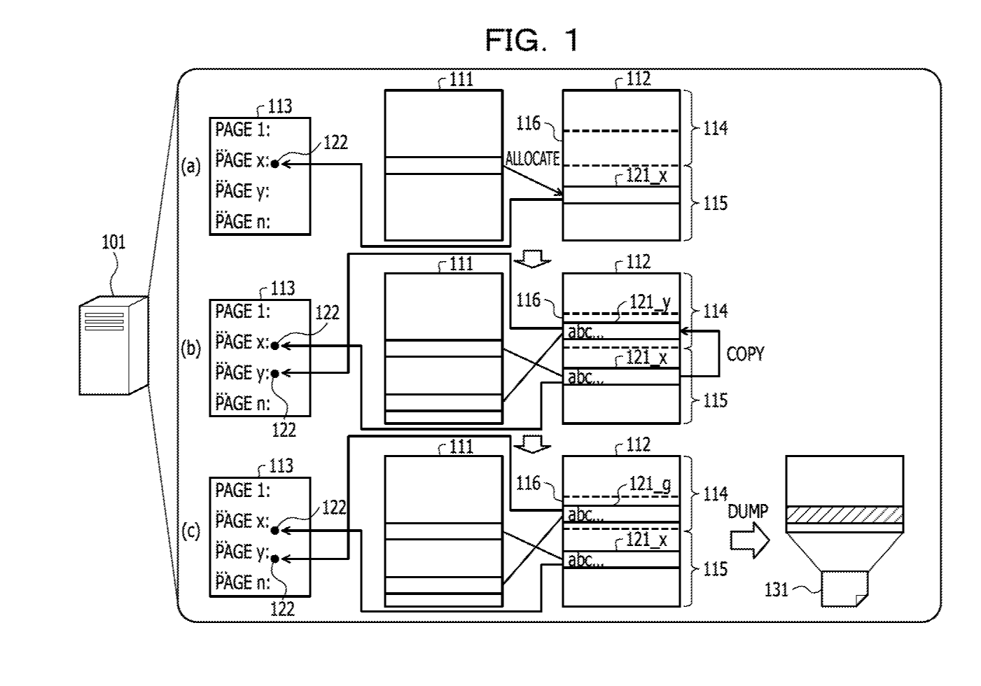

FIG. 1 is an explanatory diagram illustrating an operation example of an information processing apparatus 101 according to a first embodiment. The information processing apparatus 101 is a computer which performs processing using data including information of a user of the information processing apparatus 101. The information processing apparatus 101 is, for example, a server or a personal computer (PC).

When a trouble occurs in the information processing apparatus 101, in order to investigate a cause for the trouble, a memory dump including a file of memory data of the information processing apparatus 101 may be used.

A mechanism for memory management of the information processing apparatus 101 will be described. A kernel provides a virtual memory, which exists to efficiently use a memory for execution of multiple processes, to each of the multiple processes. In contrast to the virtual memory, a real memory is referred to as a “physical memory”. Virtual memories are used individually for respective processes. In an example provided below, for easier explanation, each program includes a single process.

Furthermore, the kernel manages the physical memory in units of divided regions. Hereinafter, a divided region will be referred to as a “page”. The size of a page may be a single size or may be different sizes. Furthermore, the data size of a page may be, for example, 4 kilobytes, 8 kilobytes, 16 kilobytes, or the like. As a mechanism for providing a physical memory corresponding to a virtual memory, a page table exists. The page table is a table which manages the correspondence between a virtual memory and a physical memory.

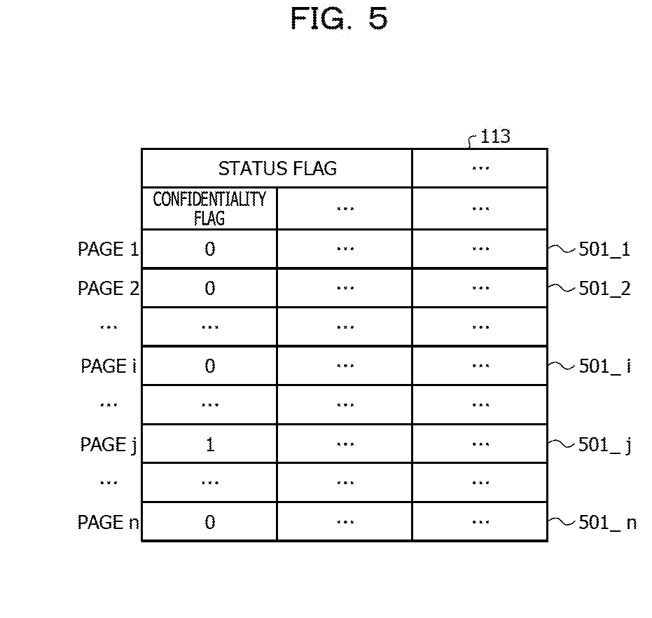

In the example of FIG. 1, the information processing apparatus 101 divides a storing region 111 of a physical memory is divided into n pages. Then, the information processing apparatus 101 manages each of the divided pages using management information 113. A specific example of the management information 113 will be described later with reference to FIG. 5.

At the time of memory dump collection, if information which is confidential, of the user of the information processing apparatus 101 is included, the information which is confidential may also be included in the memory dump. Hereinafter, the information which is confidential may be referred to as “confidential information”. The confidential information may be any type of data as long as it is data that the user does not want a third party to obtain. For example, the confidential information may be personal information of the user, name list information of clients or an unpublished business technical document of the user, secret information that the user obtains from a third party.

Nowadays, social awareness to information leakage has been increasing, and a state in which confidential information of a user of a computer is included in a memory dump in a form that may be read by a third party has been regarded as a problem. Therefore, keeping the confidential information within the memory dump secret so that the confidential information is not read by the third party has been demanded.

Techniques for keeping confidential information secret include, for example, a technique in which when a memory dump request is issued, important data which is categorized as data of a predetermined important program is encrypted, and the encrypted important data is stored into a storage device. However, when some or all of the data in a storing region of a memory is dumped, leakage of data which is confidential may occur.

Specifically, for example, in the case where confidential information which is handled by an application program is processed by a kernel, data which is obtained by copying the confidential information is stored in a storing region of a kernel space, which is a part of the storing region. When the confidential information is copied to the storing region of the kernel space, it is difficult to understand that the data of the copy destination is confidential. Therefore, when the storing region of the kernel space is dumped for failure investigation, the data of the copy destination is dumped without being encrypted, and leakage of the confidential information thus occurs.

Furthermore, data of a memory released from allocation of a program may be held until the corresponding memory region is reallocated by another program. When the released memory is dumped, the dump is performed without encryption.

In the first embodiment, a method will be described in which a flag which indicates that confidential information is stored in a page allocated to a program that is being executed in a user mode is provided, the flag is also copied when page copy to the kernel space is performed, and encryption is performed when the flag is present at the time of a dump.

The user mode is one of operation modes of a central processing unit (CPU). A kernel mode is an operation mode which is different from the user mode. In the kernel mode, there is no restriction on the CPU. In contrast, in the user mode, there is a restriction on the operation of the CPU. Specifically, in the kernel mode, the CPU is able to access all of memories, peripheral devices, and the like and execute all the commands. In contrast, in the user mode, there is a restriction on the range of a memory that the CPU can access.

The range of a memory that the CPU is able to access in the user mode will be referred to as a “user space”. The range of a memory that the CPU is not able to access in the user mode will be referred to as a “kernel space”. In the kernel mode, the CPU is able to access both of the user space and the kernel space.

The information processing apparatus 101 according to the first embodiment will be described with reference to FIG. 1. The information processing apparatus 101 allocates pages obtained by dividing a storing region 111 as physical memories of a program. A physical memory space 112 which indicates the range of a physical memory is divided into a kernel space 114 and a user space 115. Inside the kernel space, a buffer region 116 exists for temporarily storing data of an application program.

When a page is allocated to a program that is being executed in the user mode, the information processing apparatus 101 stores information 122 which indicates that data stored is confidential, in association with the allocated page. In FIG. 1, the information 122 is represented by a black circle. Furthermore, for association between the information 122 and the allocated page, the information processing apparatus 101 stores the information 122 at a point which corresponds to the allocated page inside management information 113 which manages pages. Furthermore, the information processing apparatus 101 may store the information 122 in association with the allocated page after allocation of the page or store the information 122 in association with the allocated page before allocation of the page.

Specifically, for example, as illustrated in (a) of FIG. 1, if a page fault occurs, when page 121_x is allocated to a program that is being executed in the user mode, the information processing apparatus 101 stores the information 122 at a position which corresponds to page x in the management information 113.

Next, when data stored in a page which is in the user space 115 is copied to a page which is in the kernel space 114, if the information 122 is associated with a copy source page, the information processing apparatus 101 stores the information 122 in association with a copy destination page. In this case, before copying the data, the information processing apparatus 101 stores the information 122 in association with the copy destination page.

Specifically, it is assumed that, for example, in (b) of FIG. 1, in order to cause the kernel to perform processing, the information processing apparatus 101 copies data “abc . . . ” on page 121_x which is allocated to the user space 115 to page 121_y in the buffer region 116. In this case, the information processing apparatus 101 stores the information 122 at a position which corresponds to page 121_y in the management information 113.

In the case where the page with which the information 122 is associated is included in a dump target, the information processing apparatus 101 dumps encryption data which is obtained by encrypting data stored in the page with which the information 122 is associated. Specifically, it is assumed that, for example, in (c) of FIG. 1, a program which is using a virtual memory space crashes. It is also assumed that the information processing apparatus 101 dumps the kernel space 114 as a dump target, in accordance with an instruction by an administrator of the information processing apparatus 101. In this case, page 121_y with which the information 122 is associated is included in the kernel space 114, and therefore the information processing apparatus 101 encrypts the data “abc . . . ” on page 121_y and writes the encrypted encryption data into a memory dump file 131. In the example of (c) of FIG. 1, the encryption data is represented as a hatched region.

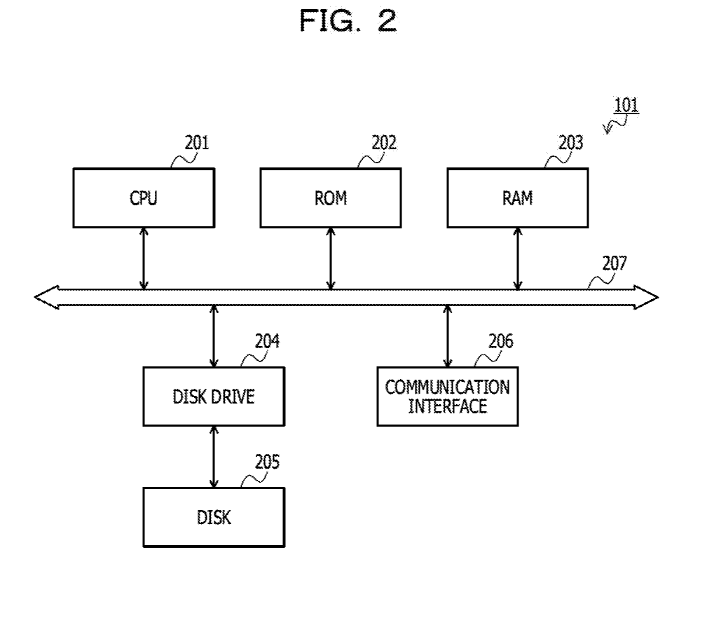

Accordingly, the information processing apparatus 101 is able to reduce leakage of the data “abc . . . ” on page 121_y, which is confidential information. Next, hardware of the information processing apparatus 101 will be described with reference to FIG. 2.

(Hardware of Information Processing Apparatus)

FIG. 2 is an explanatory diagram illustrating an example of a hardware configuration of the information processing apparatus 101. In FIG. 2, the information processing apparatus 101 includes a CPU 201, a read only memory (ROM) 202, and a random access memory (RAM) 203. The information processing apparatus 101 also includes a disk drive 204, a disk 205, and a communication interface 206. The CPU 201 to the disk drive 204 and the communication interface 206 are connected to one another via a bus 207.

The CPU 201 is an arithmetic processing device which controls the entire information processing apparatus 101. Furthermore, the information processing apparatus 101 may include multiple CPUs. The ROM 202 is a nonvolatile memory which stores a program such as a boot program. The RAM 203 is a volatile memory which is used as a work area of the CPU 201.

The disk drive 204 is a control device which controls reading and writing of data from and to the disk 205 under the control of the CPU 201. For example, a magnetic disk drive, an optical disc drive, a solid-state drive, or the like may be adopted as the disk drive 204. The disk 205 is a nonvolatile memory which stores data written under the control of the disk drive 204. For example, in the case where the disk drive 204 is a magnetic disk drive, a magnetic disk may be adopted as the disk 205. Furthermore, in the case where the disk drive 204 is an optical disc drive, an optical disc may be adopted as the disk 205. Furthermore, in the case where the disk drive 204 is a solid-state drive, a semiconductor memory which is formed of a semiconductor element, that is, a so-called semiconductor disk, may be adopted as the disk 205.

The communication interface 206 is a control device which manages interface between a network and the inside and controls input and output of data to and from an external apparatus. Specifically, the communication interface 206 is connected to an external apparatus such as, for example, a user terminal which uses the information processing apparatus 101, via a network using a communication line. For example, a modem or a local area network (LAN) adaptor may be adopted as the communication interface 206.

Furthermore, in the case where an administrator of the information processing apparatus 101 directly operates the information processing apparatus 101, the information processing apparatus 101 includes hardware such as a display, a keyboard, and a mouse, as well as the hardware illustrated in FIG. 2.

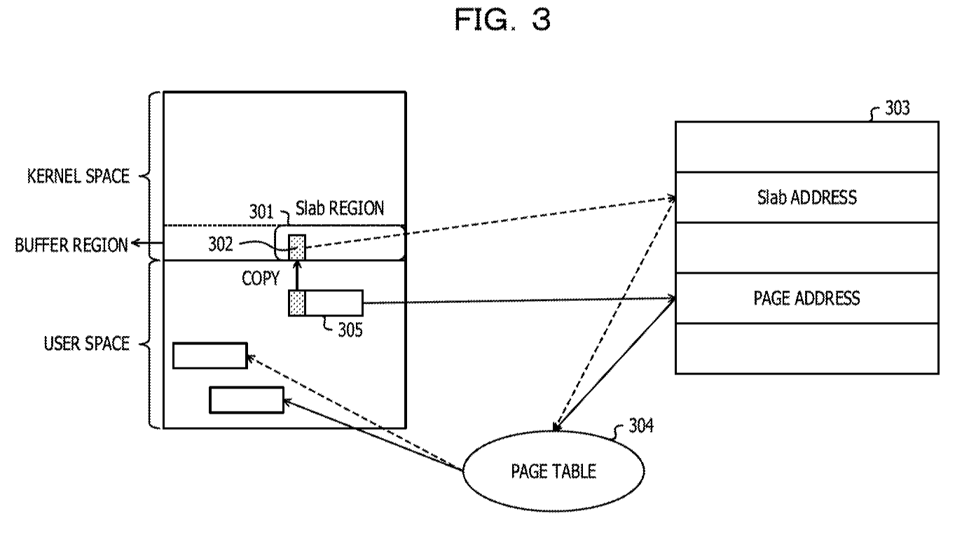

Next, a region which is secured to increase the use efficiency of a memory, for handling a region with a size smaller than a page, will be described with reference to FIG. 3.

FIG. 3 is an explanatory diagram of a region for handling a region with a size smaller than a page. The kernel secures the region for handling a region with a size smaller than a page in the kernel space. Hereinafter, the region for handling a region with a size smaller than a page will be referred to as a “slab region”. The slab region is used to copy data which is smaller than a page size.

As illustrated in FIG. 3, when data is copied to a slab region 301, the kernel secures in advance the slab region 301 to be used by a certain program. At this time, the address of a storing region 302 within the slab region 301 which is secured for the certain program is stored in a virtual memory space 303 of the program. The address of the storing region 302 is, in actuality, stored in a physical memory via a page table 304. For copying to the storing region 302, the address of the storing region 302 is read from the physical memory, and data is copied to the storing region 302.

Furthermore, in the course of processing of the program, the address of a page 305 which is to be copied to the storing region 302 is also stored in the virtual memory space 303. As with the case of the slab region 301, in actuality, the address of the page 305 is stored in the physical memory via the page table 304.

Accordingly, the address of the page 305 as a copy source in the virtual memory space 303, and the address of the storing region 302 as a copy destination, are held in the virtual memory space 303. Therefore, by referring to the virtual memory space 303, the association between data of a page and a slab region to which the data is copied may be ensured.

(Example of functional configuration of information processing apparatus)

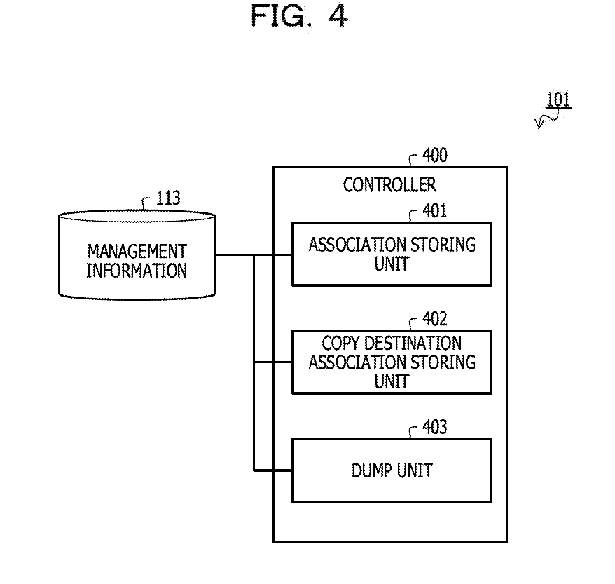

FIG. 4 is an explanatory diagram illustrating an example of a functional configuration of the information processing apparatus 101. The information processing apparatus 101 includes a controller 400. The controller 400 includes an association storing unit 401, a copy destination association storing unit 402, and a dump unit 403. The controller 400 implements a function of each unit when the CPU 201 executes a program stored in the storage device. The storage device is, specifically, for example, the ROM 202, the RAM 203, the disk 205, or the like, as illustrated in FIG. 2. Furthermore, a processing result of each unit is stored in a register of the CPU 201, a cache memory of the CPU 201, and the like.

Furthermore, the information processing apparatus 101 is able to access the management information 113. The management information 113 is stored in the kernel space.

When a page obtained by dividing a storing region is allocated to a program that is being executed in the user mode, the association storing unit 401 stores the information 122 which indicates that data stored in the page is confidential, in association with the page. Furthermore, when a page obtained by dividing a storing region is allocated to a program that is being executed in the user mode, the association storing unit 401 may associate information which indicates that data stored in the page is not confidential, with the page.

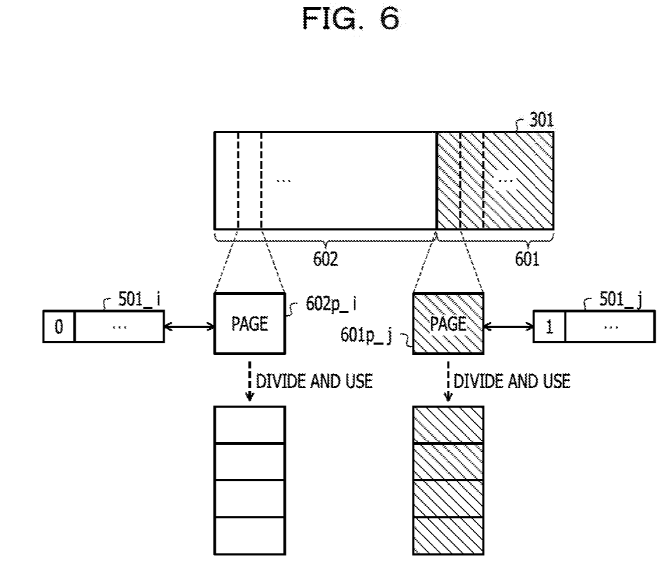

Furthermore, the association storing unit 401 may store the information 122 in association with a specific page which is in the kernel space. The specific page will be explained later with reference to FIG. 6.

Furthermore, when a page with which the information 122 is associated is allocated to a different program, the association storing unit 401 deletes the information 122 which is associated with the page. Then, if the different program is being executed in the user program, the association storing unit 401 may store the information 122 in association with the above-mentioned page.

When data stored in a page which is in a user space is copied to a page which is in a kernel space, if the information 122 is associated with the copy source page, the copy destination association storing unit 402 stores the information 122 in association with the copy destination page. Furthermore, either the information 122 or information which indicates that data stored in the page is not confidential is associated with the copy source page, and either of the two pieces of information is stored in the same storing region. In this case, the copy destination association storing unit 402 may only copy data of a region in which either of the two piece of information is stored in the copy source page to a region in which either of the two pieces of information is stored in the copy destination page.

Furthermore, in the case where data with a size smaller than a predetermined size which is stored in a page in a user space is copied to a kernel space, if the information 122 is associated with a copy source page of the above-mentioned data, the copy destination association storing unit 402 copies the data to a specific page.

In the case where a page with which the information 122 is associated is included in a dump target, the dump unit 403 dumps encryption data which is obtained by encrypting data stored in the above-mentioned page. Here, encryption may be performed in any method. For example, the dump unit 403 may adopt a common key encryption method or a public key encryption method as an encryption method.

FIG. 5 is an explanatory diagram illustrating an example of the stored contents of the management information 113. The management information 113 is information for managing pages in a physical memory. Information for managing a single page will be referred to as page management information 501.

The page management information 501 holds a flag which indicates the status of a corresponding page, such as, for example, a flag which indicates that multiple pieces of information such as the state in which data on a memory is being written to a disk is held, information of a use count, and the like. The kernel moves in accordance with acquisition or release of a memory by a program. The kernel detects the physical memory from the virtual memory based on the page table, and updates the page management information 501.

Furthermore, the page management information 501 used in this embodiment includes a confidentiality flag which indicates whether or not data stored in a page is confidential information. For example, the confidentiality flag is stored in a one-bit region of a status flag which indicates the status of a page in the page management information 501. The page management information 501 illustrated in FIG. 5 includes page management information 501_1 to 501_n. The page management information 501_i and the page management information 501_j will be described later with reference to FIG. 6.

For example, a confidentiality flag illustrated in FIG. 5 is either an identifier “1” which indicates that data stored in a page is confidential or an identifier “0” which indicates that data stored in a page is not confidential. The identifier “1” corresponds to the information 122 illustrated in FIG. 1.

As described above, with the confidentiality flag, a determination as to whether or not data stored in a page is confidential information may be made for a region of a page unit. Next, a method for determining whether or not data stored in a region with a size smaller than a page unit is confidential information will be explained with reference to FIG. 6.

FIG. 6 is an explanatory diagram illustrating an example for securing a confidential information storing region. The slab region 301 illustrated in FIG. 6 is a region for handling a region with a size smaller than a page, as explained with reference to FIG. 3. The kernel divides the slab region 301 into a confidential information storing region 601 in which confidential information is stored and a region 602 in which non-confidential information is stored, as illustrated in FIG. 6. Hereinafter, the region in which confidential information is stored will be referred to as a confidential information storing region”. In FIG. 6, the confidential information storing region 601 is illustrated as a hatched region. A page serving as the confidential information storing region 601 is the specific page illustrated in FIG. 4.

Then, the kernel sets the confidentiality flag of the page management information 501 of a page serving as the confidential information storing region 601 to “1”. In the example of FIG. 6, page 602p_i, which is one of pages serving as the region 602 in which non-confidential information is stored, is a page which is managed by the page management information 501_i, and the confidentiality flag is set to “0”. Furthermore, page 601p j, which is one of pages serving as the confidential information storing region 601, is a page managed by the page management information 501_j, and the confidentiality flag is set to “1”. Then, the confidential information with a size smaller than a page is stored in the confidential information storing region 601.

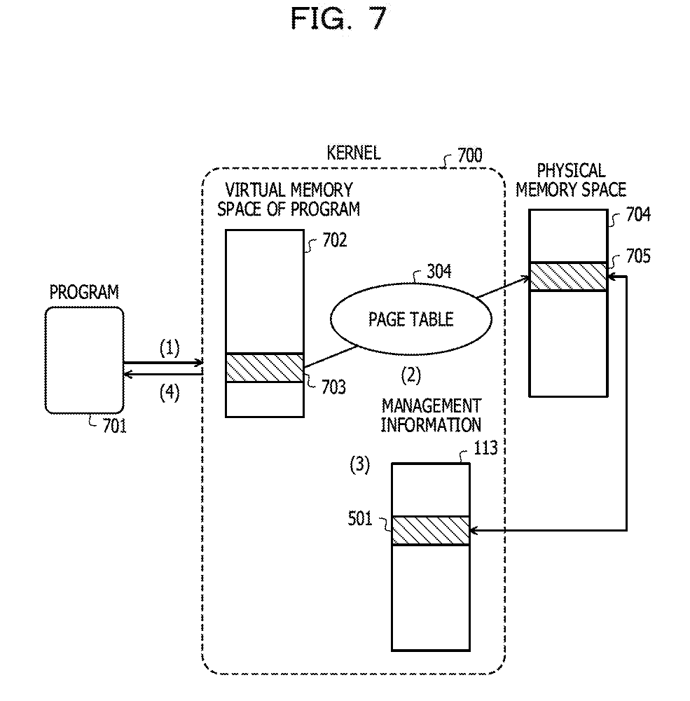

Specifically, as illustrated in FIG. 6, confidential information is stored in each region obtained by dividing page 601p_j. Similarly, non-confidential information is stored in each region obtained by dividing page 602p_i. Here, the case where data of an application program with a data size smaller than a page is stored in the slab region 301 is an example in which confidential information is stored in the confidential information storing region 601. Furthermore, the case where data of the kernel with a data size smaller than a page is stored in the slab region 301 is an example in which non-confidential information is stored in the region 602. Next, an example in which the confidentiality flag is set to 1 will be described with reference to FIG. 7.

FIG. 7 is an explanatory diagram illustrating a setting example of a confidentiality flag. As illustrated in (1) of FIG. 7, when a virtual memory 703 in a virtual memory space 702 to which the physical memory is not allocated is accessed during execution of a program 701, a page fault occurs. When a page fault occurs, processing is delivered to a memory handler of a kernel 700, and the memory handler performs allocation processing for the physical memory from a physical memory space 704, by using the page table 304, as illustrated in (2) of FIG. 7.

When a physical memory 705 to be allocated is determined, the kernel 700 determines whether or not the program 701 is being executed in the user mode, and sets a confidentiality flag based on a determination result, as illustrated in (3) of FIG. 7. Specifically, when the program 701 is being executed in the user mode, the kernel 700 sets the confidentiality flag of the page management information 501 of the physical memory 705 to “1”. In contrast, when the program 701 is being executed in the kernel mode, the kernel 700 does not set the confidentiality flag of the page management information 501 of the determined physical memory. Then, as illustrated in (4) of FIG. 7, processing returns to the program 701.

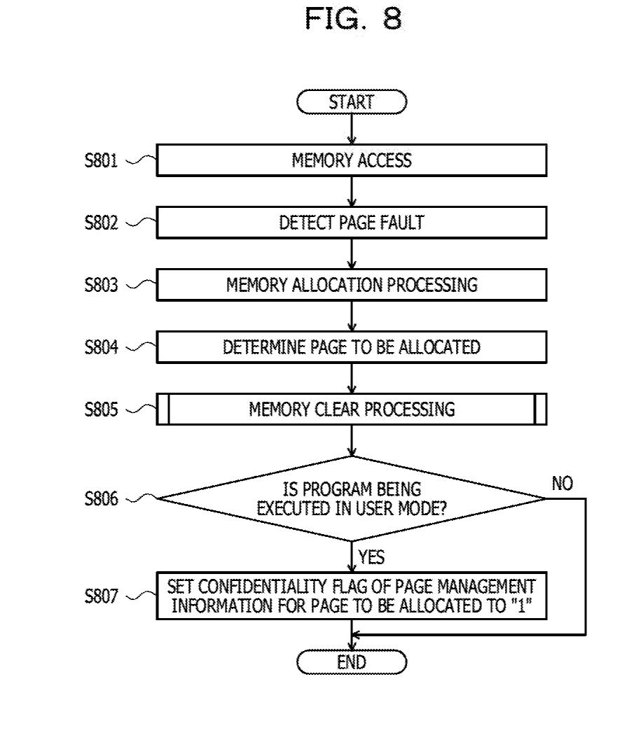

Next, a confidentiality flag setting process for setting a confidentiality flag will be described using a flowchart with reference to FIG. 8.

FIG. 8 is a flowchart illustrating an example of a procedure for a confidentiality flag setting process. The program 701 performs memory access (S801). Next, the CPU 201 detects a page fault (S802). When a page fault occurs, the process is delivered to a memory handler of the kernel 700. Then, the memory handler performs memory allocation processing for a virtual address at which the page fault has occurred (S803). The memory allocation processing may also be performed other than a timing of a page fault occurs. For example, by storing a page used in the previous execution of the program 701, when the program 701 is executed again, the stored page may be allocated.

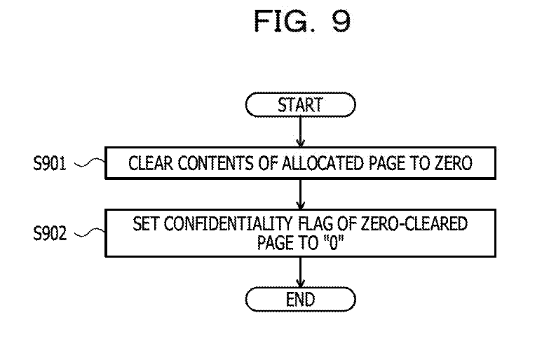

Next, the memory handler determines a page to be allocated to the program 701 (S804). Then, the memory handler performs memory clear processing for the page to be allocated (S805). The memory clear processing will be described later with reference to FIG. 9.

Next, the kernel 700 determines whether or not the program is being executed in the user mode (S806). When the program is being executed in the user mode (S806: Yes), the kernel 700 sets a confidentiality flag of page management information for the page to be allocated to “1” (S807).

When the processing of S807 ends or the program is not being executed in the user mode (S806: No), the kernel 700 ends the confidentiality flag setting process. After that, the process returns to the program 701. By performing the confidentiality flag setting process, the information processing apparatus 101 sets the confidentiality flag of the confidential information to “1”, and is therefore able to identify a target of encryption.

Next, a flowchart of a memory clear process will be described with reference to FIG. 9. When the program which handles confidential information ends, the page used by the program and the page management information 501 are not deleted until they are used by a different program. When the different program uses the page, the memory handler clears the memory contents to zero. After zero clear is completed, the confidentiality flag is set to “0”, and is delivered to be used by the different program.

FIG. 9 is a flowchart illustrating an example of a procedure for the memory clear process. The memory handler clears the contents of the allocated page to zero (S901). Next, the memory handler sets the confidentiality flag of the zero-cleared page to “0” (S902). In the case where “1” as the information 122 has been set, when the confidentiality flag is set to “0”, “1” is overwritten to “0”, which means deletion of the information 122. After the processing of S902 ends, the memory handler ends the memory clear process.

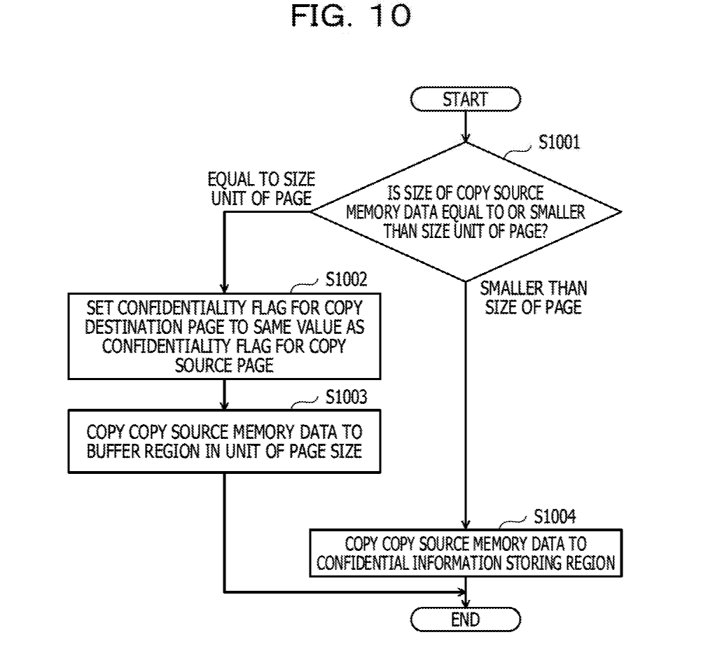

Next, a flowchart of a buffer region copy process for copying data from a user space to a kernel space will be described with reference to FIG. 10. The buffer region copy process is performed by the kernel 700. Specifically, for example, in the case where a program in the user mode stores data into a buffer region, the process is delivered to the kernel 700, and the kernel 700 performs the buffer region copy process. At this time, the kernel 700 identifies a program as a request source. FIG. 10 illustrates an example of a case where the program as a request source is the program 701 that is being executed in the user mode.

FIG. 10 is a flowchart illustrating an example of a procedure for the buffer region copy process. The kernel 700 determines whether the size of copy source memory data is equal to the size unit of a page or smaller than the size unit of a page (S1001). When the size of the copy source memory data is equal to the size unit of a page (S1001: size unit of a page), the kernel 700 sets the confidentiality flag for a copy destination page to the same value as the confidentiality flag for a copy source page (S1002). Then, the kernel 700 copies the copy source memory data to the buffer region in the unit of page size (S1003).

In contrast, when the size of the copy source memory data is smaller than the size of a page (S1001: smaller than the size of a page), the kernel 700 copies the copy source memory data to the confidential information storing region 601 (S1004).

After the processing of S1003 or S1004 ends, the kernel 700 ends the buffer region copy process. After that, the process returns to the program 701. By performing the buffer region copy process, the information processing apparatus 101 is able to define the data of the copy destination page, to which the confidential information is copied, as confidential information.

Furthermore, in the process illustrated in FIG. 10, the program as the request source is a program that is being executed in the user mode. Therefore, the kernel 700 performs processing for copying the copy source memory data to the confidential information storing region 601. However, the processing is not limited to this. For example, the kernel 700 may refer to the virtual memory space of the request source program and acquire the confidentiality flag of the page management information 501 for a page corresponding to the copy source memory data. Then, when the acquired confidentiality flag indicates “1”, the kernel 700 copies the copy source memory data to the confidential information storing region 601. When the acquired confidentiality flag indicates “0”, the kernel 700 copies the copy source memory data to the region 602 in which non-confidential information is stored.

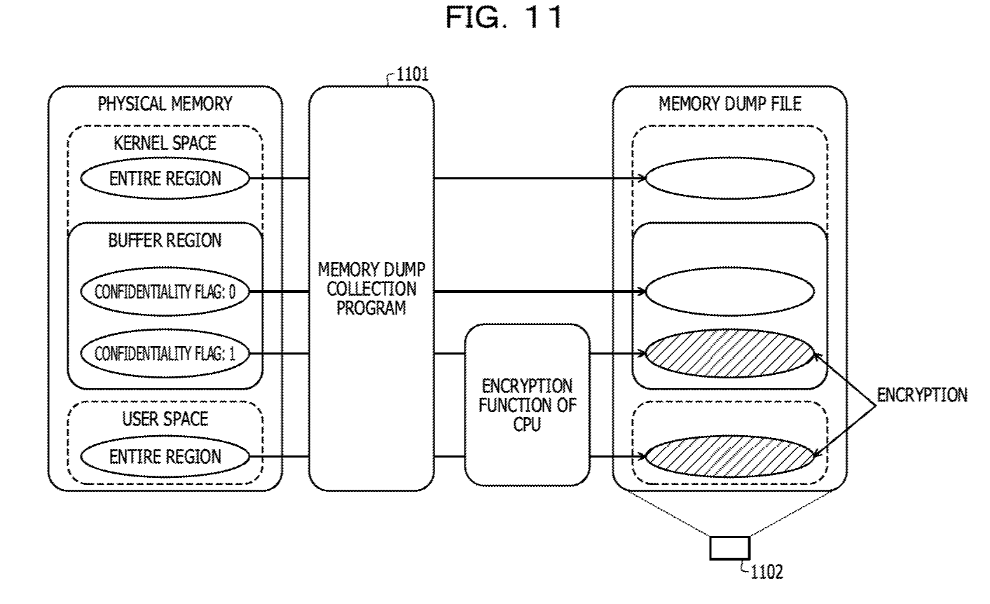

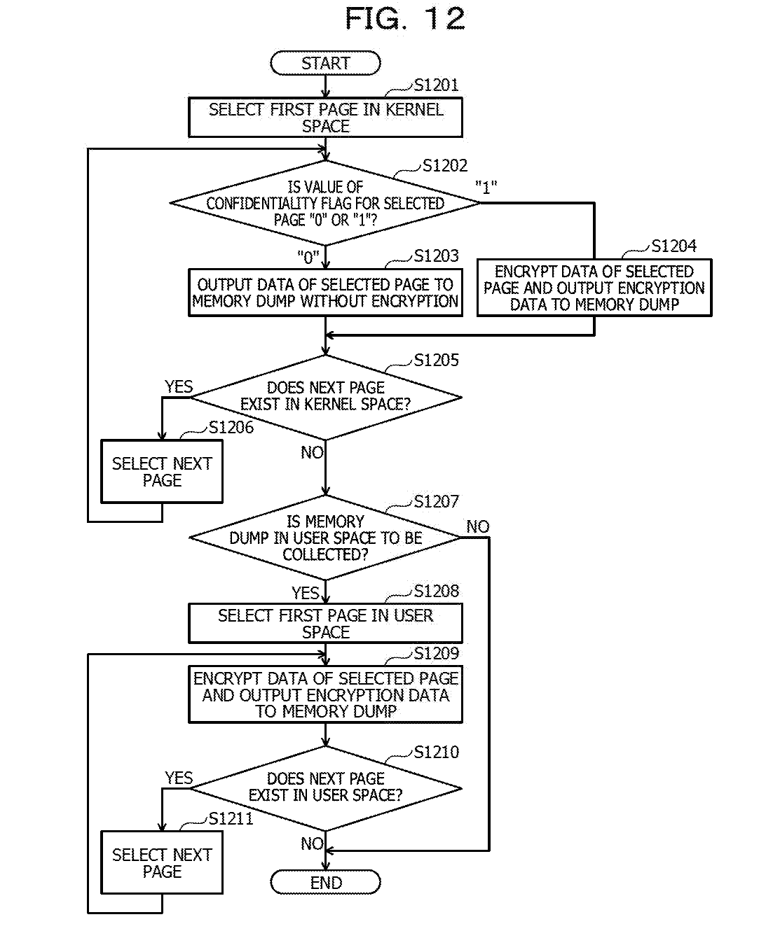

Next, an example of memory dump collection will be described with reference to FIG. 11, and an example of a procedure for a memory dump collection process will be described with reference to FIG. 12.

FIG. 11 is an explanatory diagram illustrating an example of memory dump collection. When a trouble such as system down occurs, a program for executing a memory dump collection process starts. The program for executing the memory dump collection process will be referred to as a memory dump collection program 1101, as illustrated in FIG. 11. The memory dump collection program 1101 is executed by the CPU 201.

The memory dump collection program 1101 writes data of a physical memory as a memory dump to a memory dump file 1102 on a page-by-page basis. The memory dump collection program 1101 checks for a memory in a kernel space as to whether or not the confidentiality flag of the page management information 501 for the next page is “1”. When the confidentiality flag indicates “1”, the memory dump collection program 1101 encrypts the page by using the encryption function of the CPU 201 and then performs output to the memory dump. The confidentiality flag of the page management information 501 for a page in the confidential information storing region 601 is “1”, and therefore the above determination may be achieved by this method. Accordingly, the memory dump collection program 1101 is not needed to separately perform a determination as to whether or not encryption of data in the confidential information storing region 601 is to be performed.

In contrast, the memory dump collection program 1101 directly outputs the page whose confidentiality flag indicates “0” to the memory dump without encryption. The memory dump collection program 1101 repeats processing corresponding to the confidentiality flag of the page management information 501 until all the pages in the kernel space are output as memory dumps. Meanwhile, the information processing apparatus 101 may make a selection for a memory in a user space such that collection is not performed based on setting of memory dump collection. In the case where the memory in the user space is collected, the memory dump collection program 1101 encrypts all the pages and outputs the encrypted pages to the memory dumps. After the memory dump collection program 1101 outputs all the pages in the kernel space and the user space as memory dumps, the memory dump collection process ends.

In the example illustrated in FIG. 11, hatched regions in the memory dump file 1102 are encrypted regions. Next, the flowchart of the memory dump collection process will be described with reference to FIG. 12.

FIG. 12 is a flowchart illustrating an example of the procedure for the memory dump collection process. The memory dump collection program 1101 selects the first page in a kernel space (S1201). Next, the memory dump collection program 1101 determines whether the value of the confidentiality flag for the selected page is “0” or “1” (S1202). When the value of the confidentiality flag is “0” (S1202: “0”), the memory dump collection program 1101 outputs data of the selected page to a memory dump without encryption (S1203).

In contrast, when the value of the confidentiality flag is “1” (S1202: “1”), the memory dump collection program 1101 encrypts the data of the selected page and outputs the encryption data to the memory dump (S1204).

After the processing of S1203 or S1204 ends, the memory dump collection program 1101 determines whether or not the next page exits in the kernel space (S1205). When the next page exists in the kernel space (S1205: Yes), the memory dump collection program 1101 selects the next page (S1206). Then, the memory dump collection program 1101 moves onto the processing of S1202.

In contrast, when the next page does not exist in the kernel space (S1205: No), the memory dump collection program 1101 determines whether or not a memory dump in a user space is to be collected (S1207). When a memory dump in a user space is to be collected (S1207: Yes), the memory dump collection program 1101 selects the first page in the user space (S1208).

Then, the memory dump collection program 1101 encrypts data of the selected page and outputs the encryption data to the memory dump (S1209). Next, the memory dump collection program 1101 determines whether or not the next page exists in the user space (S1210). When the next page exists in the user space (S1210: Yes), the memory dump collection program 1101 selects the next page (S1211). Then, the memory dump collection program 1101 moves onto the processing of S1209.

When a memory dump in a user space is not to be collected (S1207: No) or when the next page does not exist in the user space (S1210: No), the memory dump collection program 1101 ends the memory dump collection process. By performing the memory dump collection process, the information processing apparatus 101 is able to encrypt confidential information and perform a dump.

Next, a decryption process for decrypting the memory dump illustrated in FIG. 12 will be described. In the collected memory dump, an encrypted part, that is, a user's confidential information part, and a non-encrypted part exist. In most cases of trouble investigations using memory dumps, the user's confidential information part is not needed to be referred to, and a request for decryption of the encrypted part does not occur. However, to find a cause in a trouble examination, decryption may be performed. In this case, the encrypted part is decrypted by using a decryption key, and a new dump file is output. An apparatus which performs decryption processing may be the information processing apparatus 101 or a difference apparatus. In the example provided below, for a simpler explanation, the information processing apparatus 101 performs decryption processing.

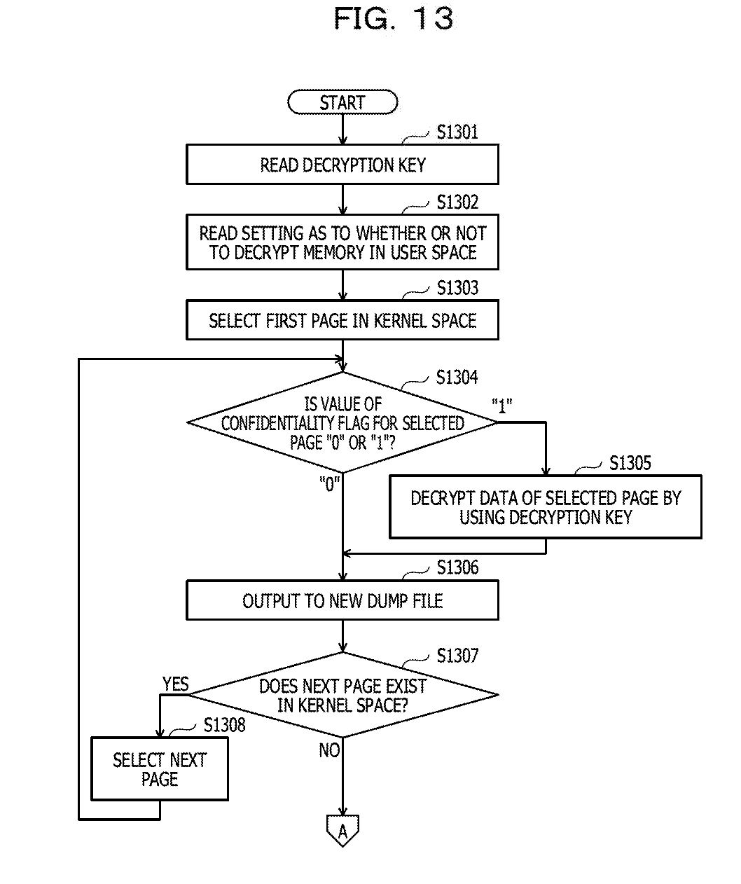

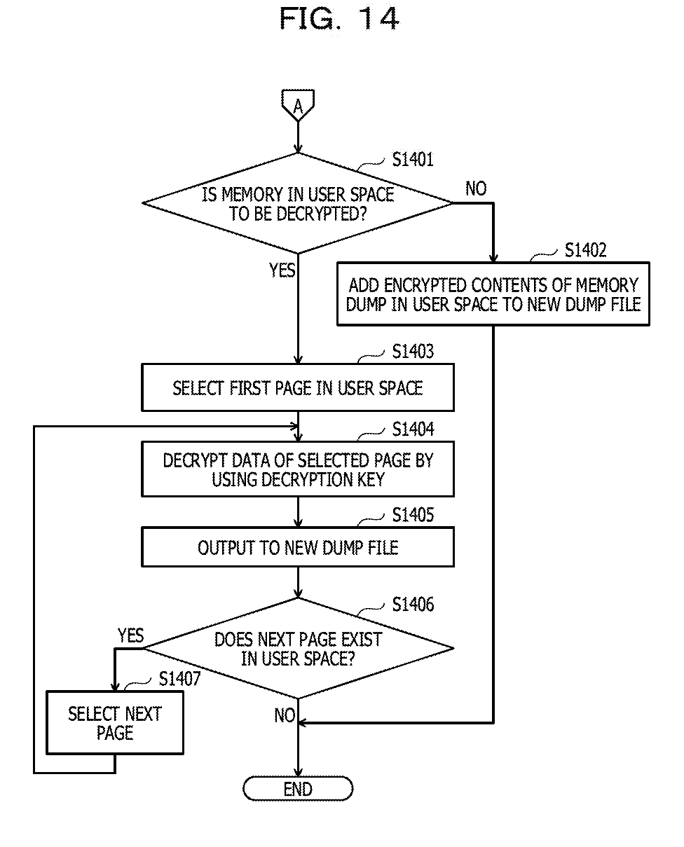

For decryption of the encrypted memory dump, the information processing apparatus 101 uses the page management information 501 included in the memory dump. The page management information 501 is present in the kernel space and is not encrypted. Therefore, by referring to confidentiality flag in the page management information 501, a determination as to whether or not a target page is encrypted may be made. Furthermore, the user space is less likely to be used for investigation compared to the memory in the kernel space, and therefore a determination as to whether or not the user space is to be decrypted may be made. Flowcharts of a decryption process will be described with reference to FIGS. 13 and 14.

FIG. 13 is a first flowchart illustrating an example of a procedure for a decryption process. FIG. 14 is a second flowchart illustrating an example of the procedure for the decryption process. The information processing apparatus 101 reads a decryption key (S1301). Next, the information processing apparatus 101 reads setting as to whether or not a memory in a use space is to be decrypted (S1302). Then, the information processing apparatus 101 selects the first page in a kernel space (S1303).

Next, the information processing apparatus 101 determines whether the value of the confidentiality flag for the selected page in the memory dump as a decryption target is “0” or “1” (S1304). When the value of the confidentiality flag is “1” (S1304: “1”), the information processing apparatus 101 decrypts the data of the selected page by using a decryption key (S1305).

After the processing of S1305 ends or when the value of the confidentiality flag is “0” (S1304: “0”), the information processing apparatus 101 performs output to a new dump file (S1306). Specifically, when the processing of S1305 ends, the information processing apparatus 101 outputs data obtained by decryption to a new dump file. Meanwhile, when the determination result in S1304 is “0”, the information processing apparatus 101 directly outputs the data of the selected page to a new dump file.

Then, the information processing apparatus 101 determines whether or not the next page exists in the kernel space (S1307). When the next page exists in the kernel space (S1307: Yes), the information processing apparatus 101 selects the next page (S1308). Then, the information processing apparatus 101 moves onto the processing of S1304.

In contrast, when the next page does not exist in the kernel space (S1307: No), the information processing apparatus 101 determines whether or not the memory in the user space is to be decrypted (S1401). When the memory in the user space is not to be decrypted (S1401: No), the information processing apparatus 101 adds the encrypted contents of the memory dump in the user space to a new dump file (S1402). After the processing of S1402 ends, the information processing apparatus 101 ends the decryption process.

In contrast, when the memory in the user space is to be decrypted (S1401: Yes), the information processing apparatus 101 selects the first page in the user space (S1403). Next, the information processing apparatus 101 decrypts data of the selected page by using a decryption key (S1404). Then, the information processing apparatus 101 outputs data obtained by decryption to a new dump file (S1405). Next, the information processing apparatus 101 determines whether or not the next page exists in the user space (S1406). When the next page exists in the user space (S1406: Yes), the information processing apparatus 101 selects the next page (S1407). Then, the information processing apparatus 101 moves onto the processing of S1404.

In contrast, when the next page does not exist in the user space (S1406: No), the information processing apparatus 101 ends the decryption process. By performing the decryption process, the information processing apparatus 101 is able to decrypt the encrypted dump file and use the decrypted confidential information to find a cause.

As described above, the information processing apparatus 101 provides a flag which indicates that confidential information is stored in a page allocated to a program that is being executed in the user mode, copies the flag when the page is coped to the kernel space, and encrypts the flag when a dump is performed. Accordingly, the information processing apparatus 101 is able to identify confidential information of a copy destination in the kernel space and reduce leakage of the confidential information.

Furthermore, the information processing apparatus 101 may store data with a size smaller than a page size in the confidential information storing region 601. Accordingly, the information processing apparatus 101 is able to encrypt confidential information at the time of a dump while maintaining the use efficiency of the memory.

Furthermore, when a page with which the information 122 is associated is allocated to a different program, the information processing apparatus 101 deletes the information 122 which is associated with the page, and if the different program is being executed in the user mode, the information 122 may be stored in association with the corresponding page. Accordingly, even after the page with which the information 122 is associated is released, the information 122 allocated to the different program remains. Therefore, the information processing apparatus 101 is able to encrypt confidential information stored in the released memory.

Furthermore, the information processing apparatus 101 performs setting of a confidentiality flag of the page management information 501 and storing of confidential information into the confidential information storing region 601 during operation of the information processing apparatus 101, and therefore is not needed to perform an operation for searching for a region in which the confidential information exists at the time when memory dump collection is performed. Accordingly, the information processing apparatus 101 is able to reduce the time to be spent for memory dump collection, compared to a method for encrypting important data which is categorized as data of a predetermined important program when a memory dump request is issued and storing the encrypted important data into the storage device.

### Second Embodiment

With the approach according to the first embodiment, encryption of confidential information of a user may be achieved. In addition to this, outputting data from a specific apparatus to a different file of a memory dump, more secured encryption using a hardware key, and the like may be demanded. Thus, in a second embodiment, a confidentiality flag of the page management information 501 has multiple bits, and different flag values are set for apparatuses from which data is acquired so that different methods are used for memory dump collection. Accordingly, the above demands may be satisfied. Parts similar to those explained in the first embodiment will be referred to with same signs and explanation for those similar parts will be omitted.

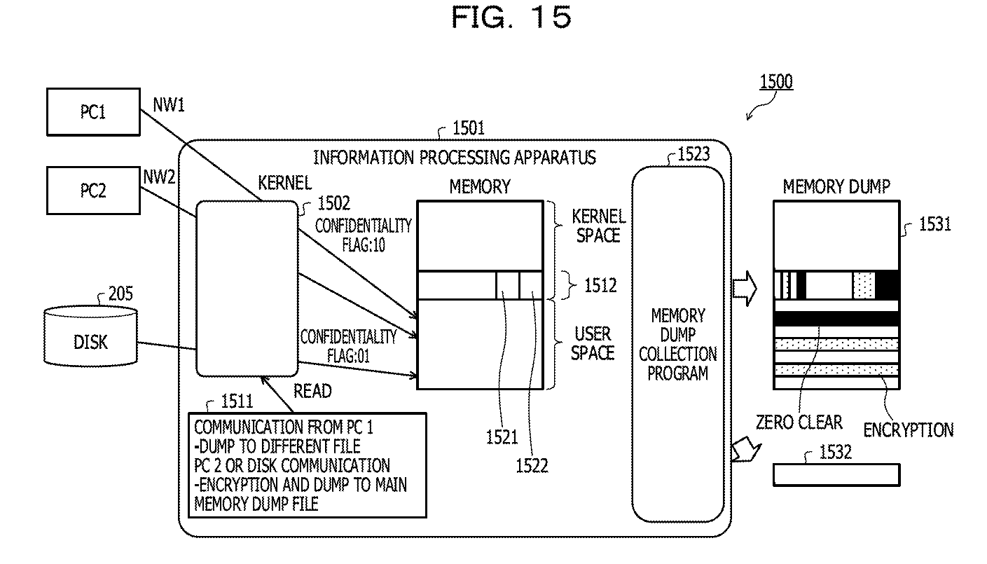

FIG. 15 is an explanatory diagram illustrating an operation example of a system 1500 according to the second embodiment. The system 1500 includes an information processing apparatus 1501, a PC 1, and a PC 2. The information processing apparatus 1501 has hardware similar to the information processing apparatus 101. The PC 1 and the PC 2 each include hardware included in the information processing apparatus 101 and hardware such as a display, a keyboard, and a mouse.

The PC 1 and the PC 2 are computers which handle confidential information of a user. Confidential information of a user is also stored in the disk 205. It is assumed that confidential information handled by the PC 1 is more important than confidential information handled by the PC 2 and confidential information stored in the disk 205 and reducing leakage of the confidential information handled by the PC 1 is more important than the confidential information handled by the PC 2 and stored in the disk 205. In order to protect such important confidential information, the PC 1 is connected with the information processing apparatus 1501 via a dedicated network NW 1. Furthermore, the PC 2 is connected with the information processing apparatus 1501 via a network NW 2 such as a local area network (LAN) or a wide area network (WAN). The information processing apparatus 1501 is connected to the network NW 1 and the network NW 2 by different network interface cards.

An example of a functional configuration of the information processing apparatus 1501 according to the second embodiment is substantially the same as the functional configuration of the information processing apparatus 101, and therefore is not illustrated in a figure. Hereinafter, functions of the association storing unit 401, the copy destination association storing unit 402, and the dump unit 403 according to the second embodiment will be described. The association storing unit 401 to the dump unit 403 described below are units according to the second embodiment.

The information processing apparatus 1501 stores setting information which indicates whether or not data acquired from each of a plurality of apparatuses connected to the information processing apparatus 1501 is confidential. Furthermore, the information processing apparatus 1501 may include information for identifying a dump destination file of data acquired from each of the apparatuses. Furthermore, the setting information may store a value which corresponds to a combination of a value indicating whether or not data acquired from each of the apparatuses is confidential and information for identifying a dump destination file.

When data is acquired from any one of the plurality of apparatuses, the association storing unit 401 refers to setting information. If the setting information indicates that the data acquired from the apparatus is confidential, the association storing unit 401 stores the information 122 in association with a page in which the data is stored.

Furthermore, when data is acquired from any one of the plurality of apparatuses, the association storing unit 401 may refer to the setting information and store identification information for identifying a dump destination file of the data acquired from the apparatus, in association with a page in which the data is stored.

When data stored in a page which is in a user space is copied to a page which is in a kernel space, if identification information is associated with the copy source page, the copy destination association storing unit 402 stores the identification information in association with the copy destination page.

In the case where a page with which identification information is associated is included in a dump target, the dump unit 403 dumps the data stored in the above-mentioned page to a dump destination file identified from the identification information.

Furthermore, in the case where the page with which the information 122 and the identification information are associated is included in the dump target, the dump unit 403 may dump encryption data which is obtained by encrypting the data stored in the above-mentioned page to the dump destination file which is identified from the identification information.

Hereinafter, an operation example in the second embodiment will be described with reference to the example illustrated in FIG. 15. First, the information processing apparatus 1501 stores a memory dump setting file 1511 in which a handling method for memory dump collection is described for each data acquisition source apparatus. The memory dump setting file 1511 stores, as a handling method for memory dump collection, a value corresponding to a combination of setting information and identification information, in association with each of a plurality of apparatuses connected to the information processing apparatus 1501.

For example, the memory dump setting file 1511 stores information of the PC 2 which indicates that data acquired from the PC 2 is confidential and a dump destination file of the data acquired from the PC 2 is a main memory dump file.

Furthermore, the memory dump setting file 1511 is created by a user operation. The memory dump setting file 1511 is read when the information processing apparatus 1501 is activated, and a kernel 1502 is able to recognize the memory dump setting file 1511. In the example of FIG. 15, in the memory dump setting file 1511, a description is provided in which dumping to a different file is performed as identification information for communication from the PC 1 and encryption is performed for the other types of communication.

The information processing apparatus 1501 provides a plurality of confidential information storing regions 601 in a buffer region 1512 within a kernel space. For example, a confidentiality flag has two bits, and three values: “10”, “01”, and “00”, are used as values corresponding to combinations of setting information and identification information. The value “10” is a value which indicates that data is acquired from the PC 1. The value “01” is a value which indicates that data is acquired from the PC 2 or the disk 205. The value “00” is a value which indicates that data is not confidential. In this case, the information processing apparatus 1501 provides two confidential information storing regions 601 for “10” and “01”. In FIG. 15, the information processing apparatus 1501 provides a confidential information storing region 1521 and confidential information storing region 1522 within the buffer region 1512.

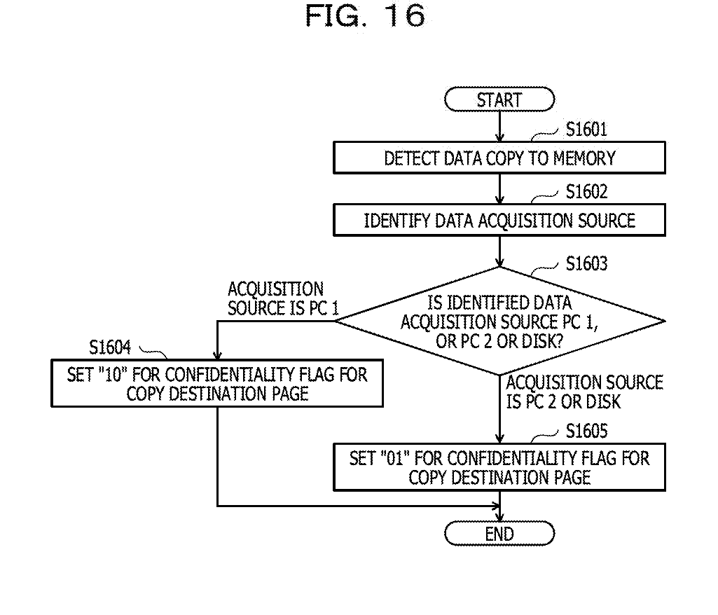

When file reading or network communication occurs, the kernel 1502 identifies a data acquisition source and checks the data acquisition source against the contents defined by the memory dump setting file 1511. In the case of communication from the PC 1, the kernel 1502 sets the confidentiality flag of the page management information 501 for a page in which the data is stored to “10”. In contrast, in the case of communication from the PC 2 or file reading to the disk 205, the kernel 1502 sets the confidentiality flag of the page management information 501 for the page in which the data is stored to “01”. A flowchart of a confidentiality flag setting process will be described later with reference to FIG. 16.

For memory dump collection, a memory dump collection program 1523 confirms the confidentiality flag of the page management information 501 for each page. When the confidentiality flag indicates “10”, data is written to a different file 1532 which is different from a main memory dump 1531. Then, the memory dump collection program 1523 clears the region to which the data is to be originally written in the main memory dump 1531 to zero. In the case where data is written to the different file 1532, if encryption and dump to a different file for communication from the PC 1 is described in the memory dump setting file 1511, the information processing apparatus 1501 performs encryption and writing to the different file 1532.

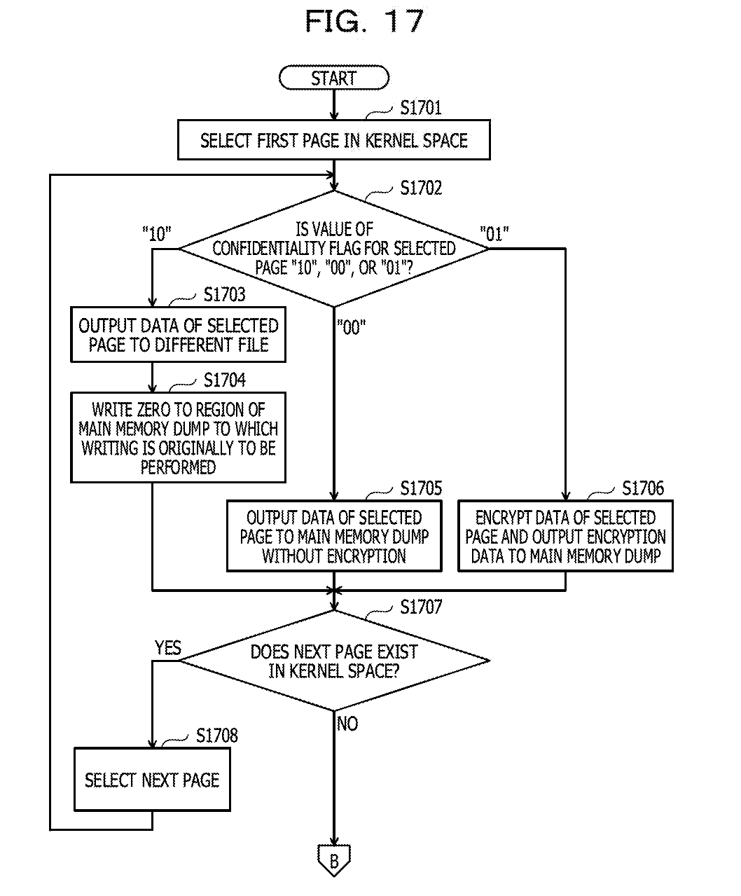

When the confidentiality flag indicates “01”, the memory dump collection program 1523 performs encryption and outputs encryption data to the main memory dump 1531. A flowchart of a memory dump collection process will be described later with reference to FIG. 17.

In the example of FIG. 15, black regions in the main memory dump 1531 represent regions which are cleared to zero, and hatched regions represent encrypted regions.

FIG. 16 is a flowchart illustrating an example of a procedure for a confidentiality flag setting process according to the second embodiment. The kernel 1502 detects data copy to a memory (S1601). Next, the kernel 1502 identifies a data acquisition source (S1602). Then, the kernel 1502 confirms a result of checking of the identified data acquisition source against a memory dump setting file (S1603).

When a checking result that the acquisition source is the PC 1 is obtained (S1603: the acquisition source is the PC 1), the kernel 1502 sets “10” for the confidentiality flag for a copy destination page (S1604). Furthermore, when a checking result that the acquisition source is the PC 2 or the disk 205 (S1603: the acquisition source is the PC 2 or the disk), the kernel 1502 sets “01” for the confidentiality flag for the copy destination page (S1605). After the processing of S1604 or S1605 ends, the kernel 1502 ends the confidentiality flag setting process.

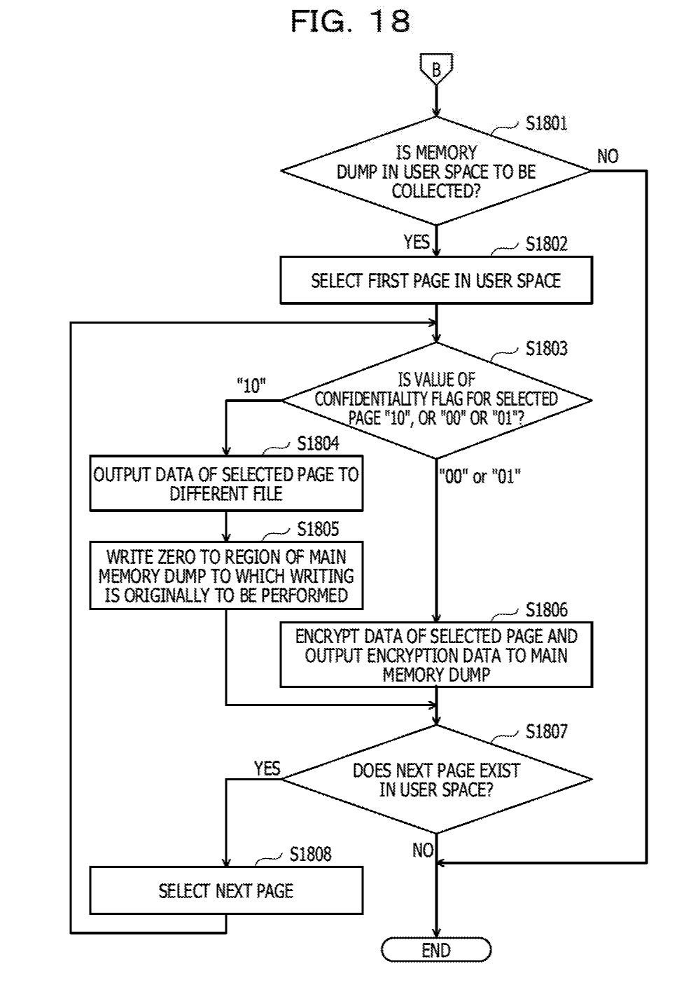

FIG. 17 is a first flowchart illustrating an example of a procedure for a memory dump collection process according to the second embodiment. FIG. 18 is a second flowchart illustrating an example of the procedure for the memory dump collection process according to the second embodiment.

The memory dump collection program 1523 selects the first page in a kernel space (S1701). Next, the memory dump collection program 1523 determines whether the value of the confidentiality flag for the selected page is “10”, “00”, or “01” (S1702). When the value of the confidentiality flag for the selected page is “10” (S1702: “10”), the memory dump collection program 1523 outputs data of the selected page to a different file (S1703). Then, the memory dump collection program 1523 writes zero to a region of the main memory dump to which writing is originally to be performed (S1704).

When the value of the confidentiality flag for the selected page is “00” (S1702: “00”), the memory dump collection program 1523 outputs the data of the selected page to the main memory dump without encryption (S1705). Furthermore, when the value of the confidentiality flag for the selected page is “0” (S1702: “01”), the memory dump collection program 1523 encrypts the data of the selected page and outputs the encryption data to the main memory dump (S1706).

After execution of any one of S1704 to S1706 is completed, the memory dump collection program 1523 determines whether or not the next page exists in the kernel space (S1707). When the next page exists in the kernel space (S1707: Yes), the memory dump collection program 1523 selects the next page (S1708). Then, the memory dump collection program 1523 moves onto the processing of S1702.

In contrast, when the next page does not exist in the kernel space (S1707: No), the memory dump collection program 1523 determines whether or not to collect a memory dump in a user space (S1801). When a memory dump in a user space is to be collected (S1801: Yes), the memory dump collection program 1523 selects the first page in the user space (S1802). Next, the memory dump collection program 1523 determines whether the value of the confidentiality flag for the selected page is “10”, “00”, or “01” (S1803).

When the value of the confidentiality flag for the selected page is “10” (S1803: “10”), the memory dump collection program 1523 outputs data of the selected page to a different file (S1804). Then, the memory dump collection program 1523 writes zero to a region of the main memory dump to which writing is originally to be performed (S1805).

When the value of the confidentiality flag for the selected page is “00” or “01” (S1803: “00” or “01”), the memory dump collection program 1523 encrypts the data of the selected page and outputs the encryption data to the main memory dump (S1806).

After the processing of S1805 or S1806 ends, the memory dump collection program 1523 determines whether or not the next page exists in the user space (S1807). When the next page exists in the user space (S1807: Yes), the memory dump collection program 1523 selects the next page (S1808). Then, the memory dump collection program 1523 moves onto the processing of S1803.

When the memory dump in the user space is not to be collected (S1801: No) or when the next page does not exist in the user space (S1807: No), the memory dump collection program 1523 ends the memory dump collection process.

A process for decrypting the memory dump obtained by the memory dump collection process according to the second embodiment is equivalent to the memory dump collection process according to the first embodiment. Therefore, the memory dump decryption process will not be illustrated. Specifically, in the decryption process according to the second embodiment, different decryption keys are provided for multiple confidentiality flags. Therefore, the information processing apparatus 1501 may perform the decryption process according to the first embodiment by using a decryption key corresponding to the value of a confidentiality flag. Accordingly, the information processing apparatus 1501 is able to obtain a decrypted memory dump.

As described above, the information processing apparatus 1501 may store the information 122 in association with a page in which data is stored, as long as information indicating that data acquired from any one of the plurality of apparatuses is confidential is provided. Accordingly, the information processing apparatus 1501 is able to encrypt only data acquired from an apparatus which includes confidential information.

Furthermore, the information processing apparatus 1501 may store identification information for identifying a dump destination file of data acquired from any apparatus by referring to setting information, in association with a divided region in which the data is stored. Accordingly, the information processing apparatus 1501 is able to store more important confidential information into a dump destination file which is different from the main memory dump. Then, the information processing apparatus 1501 is able to reduce the risk of leakage of more important confidential information, that is, for example, the risk that as a result of leakage of a secret key or the like, which allows a third party to decrypt the main memory dump, the more important confidential information may be obtained by the third party.

Furthermore, in the case where the page with which the information 122 and the identification information are associated is included in a dump target, the information processing apparatus 1501 may dump encryption data obtained by encrypting data stored in the page to a dump destination file identified from the identification information. Accordingly, the information processing apparatus 1501 may store the more important confidential information into a dump destination file which is different from the main memory dump, and encryption may further be performed. Therefore, even if the third party obtains the encryption data obtained by encrypting the more important confidential information by leakage of the different dump destination file, the third party is not able to perform decryption, and therefore the information processing apparatus 1501 is able to reduce to risk of leakage of the more important confidential information.

Furthermore, the dump processing method explained in the first and second embodiments is a method for determining, based on the confidentiality flag of page management information, whether or not confidential information is included but not a method unique to a memory dump. Therefore, the dump processing method described in the first and second embodiments may also be applied to core dump collection of the process.

The dump processing method described in the first and second embodiments may be implemented when a prepared program is executed by a computer such as a personal computer or a work station. The dump processing program is executed by being stored in a computer-readable recording medium such as a hard disk, a flexible disk, a compact disc-read only memory (CD-ROM), or a digital versatile disk (DVD) and read by the computer from the recording medium. Furthermore, the dump processing program may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer readable medium having stored therein a program that causes a computer to execute a process, the process comprising:
allocating a first divided region in a user space to a first program that is being executed in a user mode, the first divided region being one of a plurality of divided regions obtained by dividing a storing region of a memory;
storing information which indicates that the data to be stored is confidential, in association with the first divided region allocated to the first program;
storing, when data stored in the first divided region is copied to a second divided region in a kernel space among the plurality of divided regions of the storing region and when the information is associated with the first divided region, the information in association with the second divided region; and
dumping, in a case where the second divided region with which the information is associated is included in a dump target, encryption data which is obtained by encrypting the data stored in the second divided region.

2. The non-transitory computer readable medium according to claim 1, wherein
the storing region is divided into the plurality of divided regions of a predetermined size, and
the process further comprising:
storing the information in association with the second divided region in the kernel space; and
copying the data to the second divided region when the information is associated with the first divided region from which the data is copied in a case where data with a size smaller than the predetermined size stored in the first divided region in the user space is copied to the second divided region in the kernel space.

3. The non-transitory computer readable medium according to claim 1, wherein the process further comprising:
deleting, when a divided region with which the information is associated is allocated to a second program which is different from the first program, the information which is associated with the divided region; and
storing, when the second program is being executed in the user mode, the information in association with the divided region.

4. The non-transitory computer readable medium according to claim 1,
wherein the process further comprising storing, in accordance with each of a plurality of apparatuses coupled to the computer, setting information which indicates whether or not data acquired from the apparatus is confidential, and
wherein the storing the information in association with the second divided region includes, when data is acquired from any one of the plurality of apparatuses and when the setting information indicates that the data acquired from the apparatus is confidential, storing the information in association with the second divided region in which the data is stored.

5. The non-transitory computer readable medium according to claim 4, wherein
the setting information includes, in association with each of the plurality of apparatuses, identification information for identifying a dump destination file of the data acquired from the apparatus, and
the process further comprising:
storing, when data is acquired from any one of the plurality of apparatuses, the identification information for identifying the dump destination file of the data acquired from the apparatus by referring to the setting information, in association with a divided region in which the acquired data is stored;
storing, when data which is stored in the divided region in the user space is copied to the divided region in the kernel space and when the identification information is associated with the divided region from which the data is copied, the identification information in association with the divided region to which the data is copied; and
dumping, in a case where the divided region with which the identification information is associated is included in the dump target, the data stored in the divided region to the dump destination file identified from the identification information.

6. The non-transitory computer readable medium according to claim 5, wherein the process further comprising:
dumping, in a case where the divided region with which the information and the identification information are associated is included in the dump target, encryption data which is obtained by encrypting the data stored in the divided region to the dump destination file identified from the identification information.

7. An information processing apparatus comprising:
a memory; and
a processor coupled to the memory and configured to
allocate a first divided region in a user space to a first program that is being executed in a user mode, the first divided region being one of a plurality of divided regions obtained by dividing a storing region of a memory,
store information which indicates that the data to be stored is confidential, in association with the first divided region allocated to the first program,
store, when data stored in the first divided region is copied to a second divided region in a kernel space among the plurality of divided regions of the storing region and when the information is associated with the first divided region, the information in association with the second divided region, and
dump, in a case where the second divided region with which the information is associated is included in a dump target, encryption data which is obtained by encrypting the data stored in the second divided region.

8. The information processing apparatus according to claim 7, wherein
the storing region is divided into the plurality of divided regions of a predetermined size, and
the processor is configured to
store the information in association with the second divided region in the kernel space, and
copy the data to the second divided region when the information is associated with the first divided region from which the data is copied in a case where data with a size smaller than the predetermined size stored in the first divided region in the user space is copied to the second divided region in the kernel space.

9. The information processing apparatus according to claim 7, wherein the processor is configured to
delete, when a divided region with which the information is associated is allocated to a second program which is different from the first program, the information which is associated with the divided region, and
store, when the second program is being executed in the user mode, the information in association with the divided region.

10. The information processing apparatus according to claim 7, wherein the processor is configured to
store, in accordance with each of a plurality of apparatuses coupled to the information processing apparatus, setting information which indicates whether or not data acquired from the apparatus is confidential, and
store, when data is acquired from any one of the plurality of apparatuses and when the setting information indicates that the data acquired from the apparatus is confidential, the information in association with the second divided region in which the data is stored.

11. The information processing apparatus according to claim 10, wherein
the setting information includes, in association with each of the plurality of apparatuses, identification information for identifying a dump destination file of the data acquired from the apparatus, and
the processor is configured to
store, when data is acquired from any one of the plurality of apparatuses, the identification information for identifying the dump destination file of the data acquired from the apparatus by referring to the setting information, in association with a divided region in which the acquired data is stored,
store, when data which is stored in the divided region in the user space is copied to the divided region in the kernel space and when the identification information is associated with the divided region from which the data is copied, the identification information in association with the divided region to which the data is copied, and
dump, in a case where the divided region with which the identification information is associated is included in the dump target, the data stored in the divided region to the dump destination file identified from the identification information.

12. The information processing apparatus according to claim 11, wherein the processor is configured to dump, in a case where the divided region with which the information and the identification information are associated is included in the dump target, encryption data which is obtained by encrypting the data stored in the divided region to the dump destination file identified from the identification information.

13. A method comprising:
allocating, by a processor, a first divided region in a user space to a first program that is being executed in a user mode, the first divided region being one of a plurality of divided regions obtained by dividing a storing region of a memory;
storing, by the processor, information which indicates that the data to be stored is confidential, in association with the first divided region allocated to the first program;
storing, by the processor, when data stored in the first divided region is copied to a second divided region in a kernel space among the plurality of divided regions of the storing region and when the information is associated with the first divided region, the information in association with the second divided region; and
dumping, by the processor, in a case where the second divided region with which the information is associated is included in a dump target, encryption data which is obtained by encrypting the data stored in the second divided region.

14. The method according to claim 13, wherein
the storing region is divided into the plurality of divided regions of a predetermined size, and
the method further comprising:
storing, by the processor, the information in association with the second divided region in the kernel space; and
copying, by the processor, the data to the second divided region when the information is associated with the first divided region from which the data is copied in a case where data with a size smaller than the predetermined size stored in the first divided region in the user space is copied to the second divided region in the kernel space.

15. The method according to claim 13, wherein the method further comprising:
deleting, by the processor, when a divided region with which the information is associated is allocated to a second program which is different from the first program, the information which is associated with the divided region; and
storing, by the processor, when the second program is being executed in the user mode, the information in association with the divided region.

16. The method according to claim 13,
wherein the method further comprising storing, by the processor, in accordance with each of a plurality of apparatuses coupled to the processor, setting information which indicates whether or not data acquired from the apparatus is confidential, and
wherein the storing the information in association with the second divided region includes, when data is acquired from any one of the plurality of apparatuses and when the setting information indicates that the data acquired from the apparatus is confidential, storing the information in association with the second divided region in which the data is stored.

17. The method according to claim 16, wherein
the setting information includes, in association with each of the plurality of apparatuses, identification information for identifying a dump destination file of the data acquired from the apparatus, and
the method further comprising:
storing, by the processor, when data is acquired from any one of the plurality of apparatuses, the identification information for identifying the dump destination file of the data acquired from the apparatus by referring to the setting information, in association with a divided region in which the acquired data is stored;
storing, by the processor, when data which is stored in the divided region in the user space is copied to the divided region in the kernel space and when the identification information is associated with the divided region from which the data is copied, the identification information in association with the divided region to which the data is copied; and
dumping, by the processor, in a case where the divided region with which the identification information is associated is included in the dump target, the data stored in the divided region to the dump destination file identified from the identification information.

18. The method according to claim 17, further comprising:
dumping, by the processor, in a case where the divided region with which the information and the identification information are associated is included in the dump target, encryption data which is obtained by encrypting the data stored in the divided region to the dump destination file identified from the identification information.
